(19) United States
(12) Patent Application Publication
(10) Pub. No.: US 2015/0046350 A1
(43) Pub. Date: Feb. 12, 2015

(54) ENSURING SOFTWARE QUALITY USING A VIRTUAL APPLIANCE

(71) Applicant: Virtual Purple, LLC, San Mateo, CA (US)

(72) Inventor: Angela Bazigos, San Carlos, CA (US)

(21) Appl. No.: 14/450,061

(22) Filed: Aug. 1, 2014

Related U.S. Application Data
(60) Provisional application No. 61/862,893, filed on Aug. 6, 2013.

(51) Int. Cl. G06Q 30/00; G06F 11/36

(52) U.S. Cl. CPC G06Q 30/018; G06F 11/3604
USPC 705/317

(57) ABSTRACT

Various embodiments relate to apparatuses and methods of ensuring software quality using a virtual appliance. A software application is built into a virtual appliance and full compliance validation is done for the virtual appliance to ensure compliance to a standard such as a governmental regulation or industry standard. Instances of the virtual appliance are implemented for Sponsors following a process for implementing the virtual appliance. Rather than ensuring compliance to the standard by performing full compliance validation for the instance of the software to be used by the Sponsor, compliance to a standard is ensured by validating that the process for implementing the virtual appliance is executed correctly for each instance of the virtual appliance for each Sponsor.

### CROSS-REFERENCE TO RELATED APPLICATION(S)

This application claims the benefit of U.S. Provisional Patent Application No. 61/862,893, entitled “ENSURING SOFTWARE QUALITY USING A VIRTUAL APPLIANCE,” filed on Aug. 6, 2013, which is incorporated by reference herein in its entirety.

### FIELD

Software systems for managing data and documentation for projects in regulated industries such as the pharmaceutical and biomedical fields, biomedical data gathering, homeland security, and the like. More particularly, relating to the verification and validation of such software systems.

### BACKGROUND

Software systems that are designed to manage data and documentation for projects that require regulatory review and approval must be certified as accurate and reliable, so that the regulatory examiners can be assured that the data is sound and the requested regulatory action is factually justified. An example of this is the software systems used to manage and control studies and trials for biomedical purposes, such as US FDA drug or new device trials. The software system must be validated under an approval process that is described below. Other governmental departments, such as Homeland Security, have similar certification requirements.

Software verification provides objective evidence that the design outputs of a particular phase of the software development life cycle meet all of the specified requirements for that phase. Software verification looks for consistency, completeness, and correctness of the software and its supporting documentation, as it is being developed, and provides support for a subsequent conclusion that software is validated. Software testing is one of many verification activities intended to confirm that software development output meets its input requirements. Other verification activities include various static and dynamic analyses, code and document inspections, walkthroughs, and other techniques.

Software validation is the process of building quality into a software system to ensure the reliability of software applications and integrity of electronic records that resides in the application. Software validation is a part of the design validation for a finished application, but is not separately defined in the Quality System regulation. For purposes of this guidance, the FDA, as one example, considers software validation to be “confirmation by examination and provision of objective evidence that software specifications conform to user needs and intended uses, and that the particular requirements implemented through software can be consistently fulfilled.” In practice, software validation activities may occur both during, as well as at the end of the software development life cycle to ensure that all requirements have been fulfilled.

Since software is usually part of a larger hardware system, the validation of software typically includes evidence that all software requirements have been implemented correctly and completely and are traceable to system requirements. A conclusion that software is validated is highly dependent upon comprehensive software testing, inspections, analyses, and other verification tasks performed at each stage of the software development life cycle. Testing of device software functionality in a simulated use environment, and user site testing are typically included as components of an overall design validation program for a software automated device. For the purposes of this document, the terms validation and verification are used interchangeably.

### An Example Validation Process for Software Systems

1) Software COTS Applications are developed and tested by the vendor using SDLC in the vendor's standard development environment (of servers, database, operating systems for each piece of hardware, ancillary software, etc.).

2) Different sponsors use different environments. A sponsor is the company (pharmaceutical, biotech, homeland security information, or the like) that submits record to the regulatory agency (FDA, Homeland Security, or the like). For example, the sponsors may use different versions of Oracle such as v10 and v11g, or may use different operating systems such as Solaris, Linux, and Windows 7. Because different sponsors use different environments, the vendor must support multiple environments. As part of supporting these multiple environments, the vendor tests the application they develop in the multiple environments that the vendor supports. A vendor typically will support only versions of software released during the last 2-3 years and will then will drop support. By testing the application they develop on multiple hardware platforms and with multiple versions of software, the vendor's application is tested as a system.

3) The vendor then sells the application (NOT the system) to the sponsor.

4) Before purchasing the application, the sponsor may choose to audit the vendor to ensure that good software engineering practices have been used for development of the application.

5) The sponsor then deploys the application based on the sponsor's environment. The sponsor assembles/installs the various components, such as the hardware, database, ancillary software, etc., to create the computer system. The sponsor then typically configures the application for their specific usage by, for example, entering values for the pre-populated lists of the application; e.g., species, race, gender, sample type (blood, urine, etc.), location, etc. Several steps are involved in this as the hardware, software and ancillary software comes from different vendors. For example, database, office productivity, and operating system software may come from Oracle and Microsoft, server hardware may come from Oracle/Sun and Hewlett Packard, and the application may come from the vendor. The sponsor then tests the application in their environment. The process of ensuring that the application functions correctly in the sponsor environment and meets the sponsor's requirements is the practical implementation of the validation process.

6) Validation at the sponsor site can take between 6 months to 2 years or more (elapsed—not person-time) for a new application, incurring significant validation costs rates that range from tens of thousands to hundreds of thousands to millions of dollars per month.

7) Upgrade and revalidation of the system is required by the sponsor as the vendors of different system components stop supporting older versions of some of the components. Upgrade and revalidation at the sponsor site can take many months.

8) A typical pharmaceutical/biomedical company may have 30-40 applications that require validation/revalidation.

A software system may be, for example, a clinical data management package that includes integration, data collection, localization, and reporting, such as Oracle Clinical. The software system may be used by a number of pharmaceutical/biomedical companies, and each company may have a number of instances of this software. Under government regulations, each instance of the software system at each sponsor must go through the above software system validation process, resulting in an exorbitant amount of validation and revalidation of the software system.

### SUMMARY

Software quality is a major issue in many industries, especially in regulated industries such as the pharmaceutical and biomedical fields, biomedical data gathering, homeland security, and the like. In fields such as these, inadequate software quality can result in pain, suffering, and even death, not to mention monetary losses such as fines, recall actions, lost wages and productivity, and the lost investment of taking a drug to market. As one example, approximately 20% of FDA recalls are due to faulty software resulting in hundreds of millions of dollars of losses. To help ensure software quality, governments often enact regulations, and industries often enact standards, which the governments require software validation to meet in order to ensure an acceptable level of software quality.

Various embodiments of the present invention are directed to apparatuses and methods of ensuring software quality using a virtual appliance. A software application is built into a virtual appliance, and full compliance validation is done for the virtual appliance to ensure compliance to a standard, such as a governmental regulation or industry standard. Instances of the virtual appliance are implemented for Sponsors following a process for implementing the virtual appliance. Rather than ensuring compliance to the standard by performing full compliance validation for the instance of the software to be used by the Sponsor, compliance to a standard is ensured by validating that the process for implementing the virtual appliance is executed correctly for each instance of the virtual appliance for each Sponsor.

### BRIEF DESCRIPTION OF THE DRAWINGS

Embodiments of the present invention will be described and explained through the use of the accompanying drawings in which:

FIG. 1 is a graphical illustration of typical steps for ensuring compliance to a validation requirement for a number of Sponsors;

FIG. 2 is a graphical illustration of steps according to an embodiment of the invention for ensuring compliance to a validation requirement for a number of Sponsors;

FIG. 3 is a flow chart illustrating exemplary operations for ensuring software quality using a virtual appliance;

FIG. 4 is a flow chart illustrating exemplary operations for ensuring software quality using a virtual appliance; and

FIG. 5 is a diagrammatic representation of a machine in the example form of a computer system within which a set of instructions, for causing the machine to perform any one or more of the methodologies or modules discussed herein, may be executed.

The drawings are not necessarily drawn to scale. For example, the dimensions of some of the elements in the figures may be expanded or reduced to help improve the understanding of the embodiments of the present invention. Similarly, some components and/or operations may be separated into different blocks or combined into a single block for the purposes of discussion of some of the embodiments of the present invention. Moreover, while the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

Discussion of the specifics of an example industry is helpful to understanding the importance and impact of software systems validation. The life sciences industry, as such an example, is currently suffering reduced growth in new drugs and medical devices due to low investments in the industry. This is adversely impacting patient care. This reduced growth has been caused by lack of investment in the life sciences industry, as the high costs and cumbersome nature of the industry are driving investors away from the US and into foreign investments, adversely impacting the US economy.

Computer systems are inextricably intertwined with the research and development of new drugs and medical devices. Consequently, a large part of the life science industry costs are due to software. The following will help shed light on some of the reasons for this:

1) Approximately 20% of FDA recalls are due to faulty software (“˜20% of Recalls are Due to Faulty Software”: Ref: Dr. Jeff Shuren, Director Center of Devices and Radiological Health (CDRH), FDA, 27 Sep. 2010, BioDesign Roundtable, Stanford). This results in hundreds of millions of dollars of losses due to patient injury or death, fines, recall actions, and the lost investment of taking a drug to market that must be recalled.

2) The Computer Systems Validation process, used to ensure compliance with 21 CFR 11, is intended to ensure that software is functioning correctly. This process is time consuming and expensive, while also being error prone and inefficient. With the goal of increasing compliance, the FDA announced in 2010 that it will step up enforcement of 21 CFR 11 compliance.

3) 21 CFR 11 inspections require specialized training for inspectors and each inspection can take 3-5 days for just one computer system. Life sciences companies have hundreds of computer systems each, each of which needs to be updated and re-inspected every 3 years. This results in requirements for hundreds of thousands of inspections, of which the FDA can only inspect a few thousand, leaving thousands of other computer systems uninspected.

The problem of reduced new medicine developed is of such magnitude that in 2011 the Obama administration provided the FDA with funding to help streamline its operations to help develop medicines. In the area of computer systems, it is not sufficient to change the FDA process, it is also necessary to change the way that computer systems validation is done. The way that computer systems are validated and inspected has not changed in over 20 years.

The current application utilizes a method described in U.S. Pat. No. 8,266,578, which issued on Sep. 11, 2012, and which is hereby incorporated by reference in its entirety. When a conflict exists between the incorporated reference and the current application, the current application supersedes the reference.

### Terminology

Brief definitions of terms, abbreviations, and phrases used throughout this application are given below.

The terms “connected” or “coupled” and related terms are used in an operational sense and are not necessarily limited to a direct physical connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

The phrases “in some embodiments,” “according to various embodiments,” “in the embodiments shown,” “in one embodiment,” “in other embodiments,” “various embodiments,” “some embodiments,” and the like generally mean the particular feature, structure, or characteristic following the phrase is included in at least one embodiment of the present invention, and may be included in more than one embodiment of the present invention. In addition, such phrases do not necessarily refer to the same embodiments or to different embodiments.

If the specification states a component or feature “may”, “can”, “could”, or “might” be included or have a characteristic, that particular component or feature is not required to be included or have the characteristic.

The term “module” refers broadly to software, hardware, or firmware (or any combination thereof) components. Modules are typically functional components that can generate useful data or other output using specified input(s). A module may or may not be self-contained. An application program (also called an “application”) may include one or more modules, or a module can include one or more application programs.

### General Description

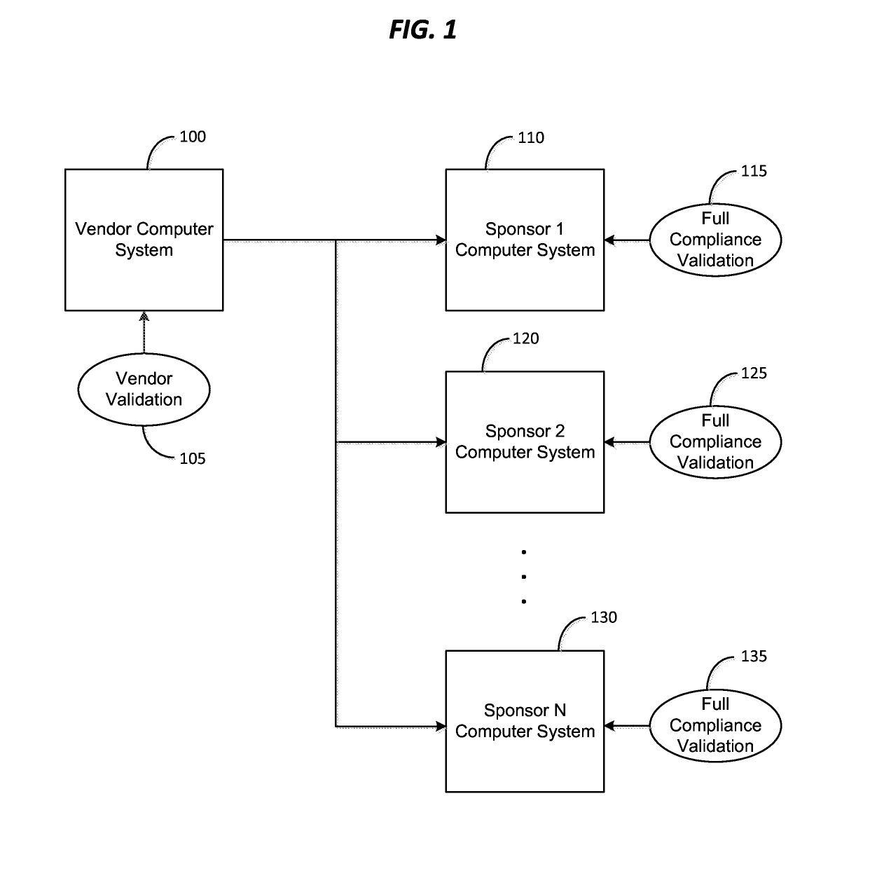

FIG. 1 illustrates typical steps for ensuring compliance to a validation requirement for a number of Sponsors. The validation requirement can be, for example, a governmental regulation such as 21 CFR 11. In this example, a vendor such as Oracle develops an application such as Oracle Clinic. The application resides on a computer of Vendor Computer System 100, and the vendor validates the application during Vendor Validation 105. Vendor Computer System 100 can be one or more computer systems, each computer system having a particular environment. For example, a particular computer system of Vendor Computer System 100 may have database software from Oracle or Microsoft, it may have Office 2010 or Office 2007 from Microsoft, it may have operating system software from Oracle/Sun or Microsoft, the physical system may be server hardware from Hewlett Packard or from Dell, the system may be connected to a local area network or a wide area network, and the system may or may not have a hardware component or peripheral from a certain vendor attached.

The combination of software and software versions along with the specific hardware, networks, components/peripherals, etc. (i.e., the combination of “things” that may affect the functionality of the system) form the particular environment of a specific computer system of Vendor Computer System 100. A vendor typically tests their application in a number of different environments. The vendor validates its application for each environment that it chooses to support, and accomplishes this validation during Vendor Validation 105 utilizing Vendor Computer System 100. Vendor Validation 105 can include validation to ensure compliance with a governmental regulation such as 21 CFR 11.

Sponsors are users of the vendor's application. A Sponsor could be, for example, a pharmaceutical that is using an application such as Oracle Clinical during a clinical drug trial. In the example of FIG. 1, Sponsor 1, who is a user of the vendor's application, implements the application on Sponsor 1 Computer System 110 by, for example, installing the application on Sponsor 1 Computer System 110. Sponsor 1 Computer System 110 has a particular environment. Because the environment of Sponsor 1 Computer System 110 is different than any of the environments of the computer systems constituting Vendor Computer System 100 in this example, it is possible that the application has a bug that manifests itself on Sponsor 1 Computer System 110, but that does not manifest itself on any of the computer systems constituting Vendor Computer System 100. This means that even if Vendor Validation 105 perfectly verified that the application has no bugs when run on the various environments of the computers constituting Vendor Computer System 100, there may still be a bug in the application when run on the environment of Sponsor 1 Computer System 110.

For example, the application may call a function from a system library. That function may work perfectly for the versions of the system library that are installed on the various computer systems that constitute Vendor Computer System 100. However, a Sponsor Computer System may have a different version of that system library installed, a version which has a bug. So, while the application running on the computer systems that constitute Vendor Computer System 100 may be completely and perfectly bug free, once installed on the Sponsor Computer System the application then calls a function from a system library that contains a bug. As a consequence of the bug in this function, the application on the Sponsor's Computer System now manifests a bug. As can be seen, this bug was introduced due to the differences of the environment of the Sponsor's Computer System. If the environment of the Sponsor's Computer System were identical to the Vendor's Computer System, then the application would function identically on both systems and there would be no bug.

The environment of Sponsor 1 Computer System 110 will very likely be different than any of the environments of the computer systems constituting Vendor Computer System 100 because there will almost invariably be some differences between these systems. As one example, one system can be connected to the Vendor's network and the other system can be connected to Sponsor 1's network, thereby making the environments of the two computer systems different. As a second example, one system can have a different version of a system library installed than the other system, similarly making the environments of the two computer systems different. Any single difference such as these can cause the application to manifest a bug on one system when it would not manifest a bug on the second system under identical test conditions.

Because the environment of a Sponsor's Computer System (such as Sponsor 1 Computer System 110) will very likely be different than any environment of Vendor Computer System 100, even a perfect Vendor Validation 100 will not catch bugs that are manifested as a consequence of the environmental differences when the vendor's application is run in the environment of the Sponsor's Computer System (such as Sponsor 1 Computer System 110). In order to ensure that the application is bug free for the Sponsor, validation must be run on the Sponsor's Computer System that contains the application (such as Sponsor 1 Computer System 110).

A Sponsor has validation requirements for the software and computer systems that they use. In some cases many Sponsors may have identical validation requirements. For example, pharmaceutical companies running a clinical trial may all have validation requirements that include a requirement to comply with the governmental regulations contained in 21 CFR 11. If there are a number “N” Sponsors who all are running the same application, for example, N pharmaceuticals who are all running clinical drug trials. And each Sponsor is using the same application, for example, Oracle Clinical. Then each Sponsor must do Full Compliance Testing to ensure that their copy of the application on their Computer System meets the validation requirements.

In the example of FIG. 1, Sponsors 1, 2, . . . , to N all run the same application, and are all required to comply with the same application validation requirement. Sponsor 1 runs the application on Sponsor 1 Computer System 110, Sponsor 2 runs the application on Sponsor 2 Computer System 120, . . . , and Sponsor N runs the application on Sponsor N Computer System 130. As is illustrated in FIG. 1, each Sponsor must do Full Compliance Validation to ensure that the application running on their computer system complies with the validation requirements. So Sponsor 1 verifies compliance with the validation requirements during Full Compliance Validation 115, Sponsor 2 verifies compliance with the validation requirements during Full Compliance Validation 125, . . . , and Sponsor N verifies compliance with the validation requirements during Full Compliance Validation 135.

As FIG. 1 makes clear, each Sponsor Computer System, even though running the same application and having to meet the same validation requirements as all other Sponsor Computer Systems, must go through Full Validation Compliance. Thus, for N systems, N Full Compliance Validations must be run, one for each Sponsor system.

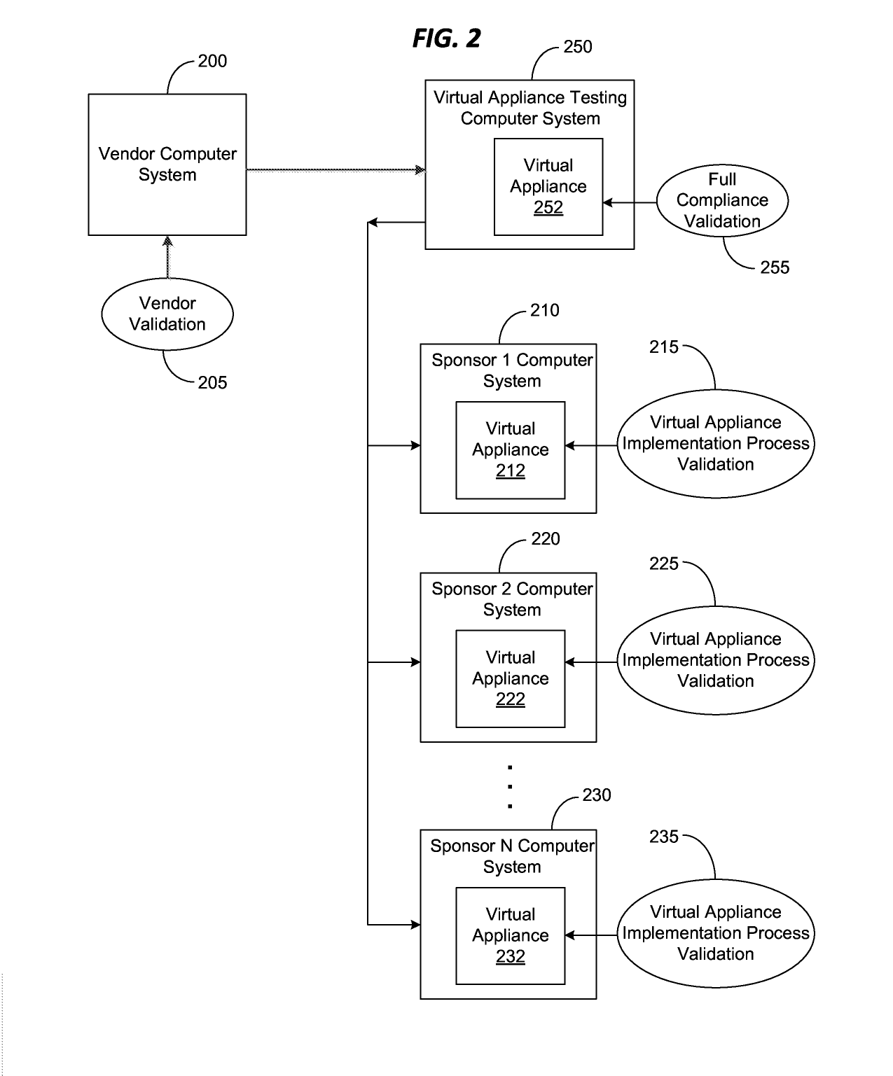

FIG. 2 illustrates steps according to an embodiment of the invention for ensuring compliance to a validation requirement for a number of Sponsors. Each Sponsor of FIG. 2 intends to use the same application for the same purpose as in the example of FIG. 1. Further, the validation requirements for the application running on the Sponsor's Computer System are the same as in the example of FIG. 1. The validation requirements can be, as in the example of FIG. 1, a governmental regulation such as 21 CFR 11. The application resides on Vendor Computer System 200, and the vendor validates the application during Vendor Validation 205. Vendor Validation 205 can be the same process as Vendor Validation 105.

After Vendor Validation 205 is completed, the application and the supporting software are built into Virtual Appliance 252 using, for example, VMware. A virtual appliance is a virtual machine designed to run on a virtual computer system (e.g., a virtualization platform from companies such as VirtualBox, Xen, VMware workstation, Parallels Workstation). In the example of FIG. 1, the application was run in many different environments. In the embodiment of FIG. 2, the application once built into a Virtual Appliance is encapsulated in a virtual computer system, the virtual computer system having a particular environment. Even though the application embedded in the Virtual Appliance is run on many different physical computer systems, the application sees only one environment, the particular environment of the virtual computer system contained in the Virtual Appliance. In some embodiments, Vendor Validation 205 can be Full Compliance Validation 255, and Vendor Computer System 200 can be Virtual Appliance Testing Computer System 250. In other words, Vendor Validation can be accomplished by running Full Compliance Validation on the Virtual Appliance. In some embodiments, Virtual Appliance Testing Computer System 250 can be part of the cloud when cloud computing is utilized.

Once the application is built into a Virtual Appliance, the Virtual appliance insulates the application from the environment of the physical computer system on which it is running while encapsulating the application in the environment of the virtual computer system. The application sees this same virtual computer system environment on every physical computer system on which the Virtual Appliance runs, regardless as to the environment of the physical computer system. Virtual Appliance 252 is running on Virtual Appliance Testing Computer System 250. All Sponsors of FIG. 2 want to run the same application, and they all desire to comply with identical software validation requirements. In some embodiments, the validation requirements of the Sponsors can differ. In contrast to FIG. 1, where Full Compliance Validation is done for each Sponsor Computer System, in the embodiment of FIG. 2, Full Compliance Validation 255 is only done once, for Virtual Appliance 252 running on Virtual Appliance Testing Computer System 250. Other embodiments can require Full Compliance Validation on more than one Virtual Appliance, can require more than one Full Compliance Validation on a Virtual Appliance, and can require validation in addition to the Full Compliance Validation.

Because the Virtual Appliance insulates the application from the environments of the various Sponsor Computer Systems and encapsulates the application in one environment, regardless of the Computer System on which the virtual appliance is run, the application does not need to have Full Compliance Validation run on each Sponsor Computer System. An example will help to illustrate why this is so.

In FIG. 1 above, an example was discussed where the application called a function from a system library, and the Vendor's Computer System and the Sponsor's Computer System each had different versions of this system library installed. The different system libraries, one with a bug and one bug free, caused the application to manifest a bug on the system with the buggy library installed. In the embodiment of FIG. 2, the same situation will not cause the application to manifest a bug. This is because the application does not see the system library that is installed on the physical computer system, but rather sees the system library of the virtualized computer system environment of the Virtual Appliance.

In the embodiment of FIG. 2, Virtual Appliance 252 can, for example, have version 2.0 of a system library installed. Sponsor 1 Computer System 210 can have buggy version 1.2 of the system library installed. Virtual Appliance 212 is an instance of Virtual Appliance 252. When Virtual Appliance 212 runs, and if it calls a function from the system library, it will not call the function from the buggy 1.2 version of the system library that is installed on Sponsor 1 Computer System 210. Rather, Virtual Appliance 212 will call the function from the system library of the virtualized computer system environment embedded in the Virtual Appliance, which is the non-buggy version 2.0. As this example helps demonstrate, the Virtual Appliance encapsulates the application in the same environment, regardless as to the physical Computer System on which any particular Virtual Appliance instance is running. The environment of the Virtual Appliance which encapsulates the application in no way depends on or is impacted by the environment of the physical Computer System on which the Virtual Appliance runs.

As the above example illustrates, in the embodiment of FIG. 2 the particularities of the environments of the Sponsor Computer Systems will not cause a bug to be manifested. This is because the application which is embedded in the Virtual Appliance is encapsulated in the same environment for all instances of the Virtual Appliance. The application always sees the same environment, regardless as to the particularities of the physical Computer System on which it is running.

Because the application always sees the same environment regardless as to the physical computer on which the Virtual Appliance is run, it is not necessary to do Full Compliance Validation on each Sponsor Computer System. Because the application is insulated from the environment of the physical computer on which the Virtual Appliance is running, there is no need to validate that the differences between the environment of Virtual Appliance Testing Computer System 250, and the environment of the particular Sponsor Computer System on which the Virtual Appliance is running, do not introduce a bug. The is because the application sees no environmental differences, as it only sees the environment of the virtual computer system of the Virtual Appliance, which is identical regardless as to the physical computer system on which the Virtual Appliance is running.

Rather than running Full Compliance Validation 255 on every Sponsor Computer System, the Sponsor only need validate that the Virtual Appliance Implementation Process happened correctly. Validation of the Virtual Appliance Implementation Process is different from Full Compliance Validation 255. This means that each of Virtual Appliance Implementation Process Validation 215, Virtual Appliance Implementation Process Validation 225, and Virtual Appliance Implementation Process Validation 235 are different than Full Compliance Validation 255. In the embodiment of FIG. 2, Virtual Appliance Implementation Process Validation 215, Virtual Appliance Implementation Process Validation 225, and Virtual Appliance Implementation Process Validation 235 have the same intentions and goals. In other embodiments, they can have different intentions and goals.

In the embodiment of FIG. 2, Full Compliance Validation 255 is intended to fully validate that the vendor application functions properly and Virtual Appliance Implementation Process Validation 215 does not have this same intent. In other embodiments, the intentions of Full Compliance Validation 255 and Virtual Appliance Implementation Process Validation 215 can be different than those of the embodiment of FIG. 2. Virtual Appliance Implementation Process Validation 215 can be intended, for example, to ensure that Virtual Appliance 252 was correctly implemented on Sponsor 1 Computer System 1 as Virtual Appliance 212. Correct implementation of the Virtual Appliance Implementation Process can include, for example, validating that Virtual Appliance 252 was correctly cloned as Virtual Appliance 212. It can further include, for example, validating that the virtual computer system software (e.g., VirtualBox, Xen, VMware workstation, Parallels Workstation) functions properly on Sponsor 1 Computer System 210.

However, because Virtual Appliance 252 has been fully functionally tested during Full Compliance Validation 255, and because Virtual Appliances insulate applications embedded within them from the particularities of the environments of the physical computer systems on which they are running, instances of Virtual Appliance 252 do not need to be functionally tested with Full Compliance Validation 255. Instances of Virtual Appliance 252, such as Virtual Appliance 212, Virtual Appliance 222, and Virtual Appliance 232, only need be validated that the Virtual Appliance Implementation Process happened correctly. Thus, Virtual Appliance 212 only need pass Virtual Appliance Implementation Process Validation 215, Virtual Appliance 222 only need pass Virtual Appliance Implementation Process Validation 225, and Virtual Appliance 232 only need pass Virtual Appliance Implementation Process Validation 235.

Because validating the Virtual Appliance Implementation Process is much simpler than a Full Compliance Validation, this leads to a significant savings of time and resource. Rather than doing N Full Compliance Validations, as in the example of FIG. 1, the embodiment of FIG. 2 only requires one Full Compliance Validation and N Virtual Appliance Implementation Process Validations. This results in a multiplication of the already significant time and resource savings.

In some embodiments, Sponsor Computer Systems can be in the cloud with the Sponsor utilizing could computing. This means, for example, that any or all of Sponsor 1 Computer System 210, Sponsor 2 Computer System 220, or Sponsor 3 Computer System 230 can be in the could with their associated Sponsor utilizing cloud computing.

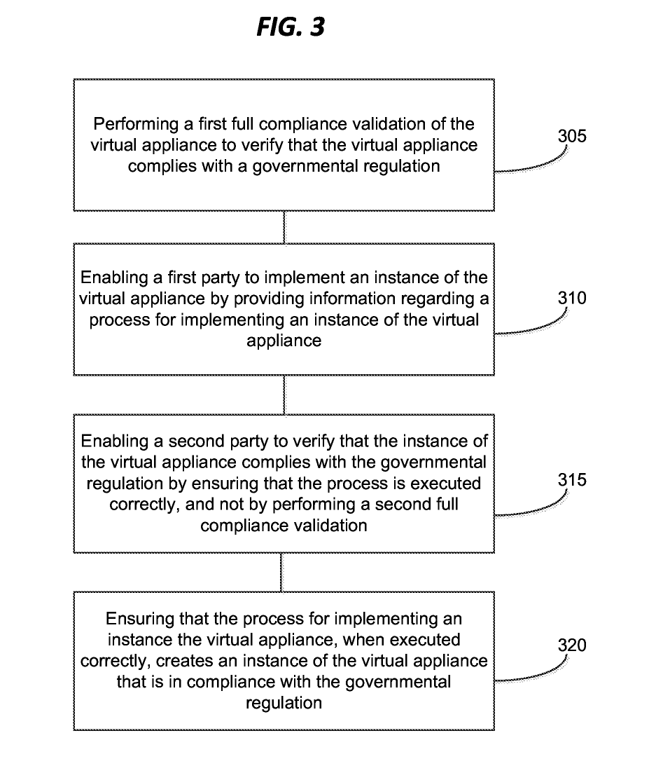

FIG. 3 is a flow chart illustrating exemplary operations for ensuring software quality using a virtual appliance. Step 305 of the method includes performing a first full compliance validation of the virtual appliance to verify that the virtual appliance complies with a governmental regulation.

Step 310 of the method includes enabling a first party to implement an instance of the virtual appliance by providing information regarding a process for implementing an instance of the virtual appliance.

Step 315 of the method includes enabling a second party to verify that the instance of the virtual appliance complies with the governmental regulation by ensuring that the process is executed correctly, and not by performing a second full compliance validation.

Step 320 of the method includes ensuring that the process for implementing an instance the virtual appliance, when executed correctly, creates an instance of the virtual appliance that is in compliance with the governmental regulation.

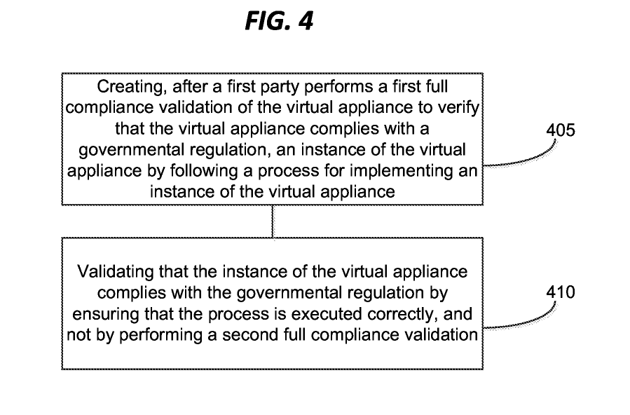

FIG. 4 is a flow chart illustrating exemplary operations for ensuring software quality using a virtual appliance. Step 405 of the method includes creating, after a first party performs a first full compliance validation of the virtual appliance to verify that the virtual appliance complies with a governmental regulation, an instance of the virtual appliance by following a process for implementing an instance of the virtual appliance.

Step 410 of the method includes validating that the instance of the virtual appliance complies with the governmental regulation by ensuring that the process is executed correctly, and not by performing a second full compliance validation.

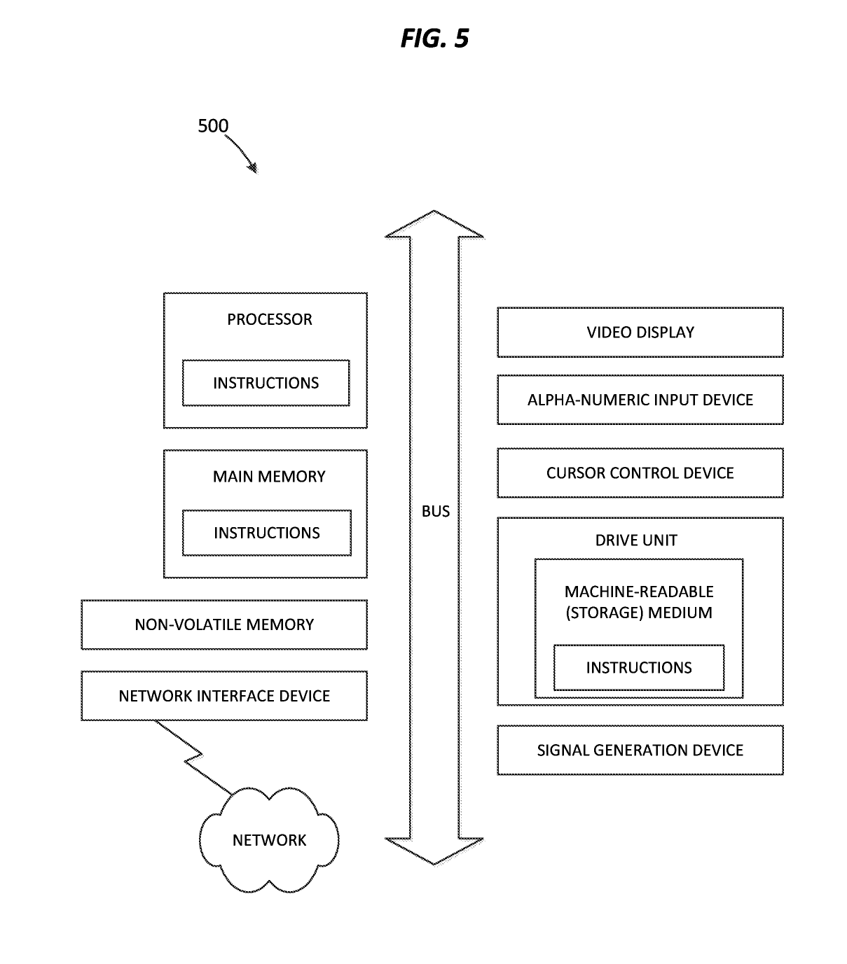

Referring now to FIG. 5, therein is shown a diagrammatic representation of a machine in the example form of a computer system 500 within which a set of instructions, for causing the machine to perform any one or more of the methodologies or modules discussed herein, may be executed.

In the example of FIG. 5, the computer system 500 includes a processor, memory, non-volatile memory, and an interface device. Various common components (e.g., cache memory) are omitted for illustrative simplicity. The computer system 500 is intended to illustrate a hardware device on which any of the components depicted in the example of FIGS. 1-4 (and any other components described in this specification) can be implemented. The computer system 500 can be of any applicable known or convenient type. The components of the computer system 500 can be coupled together via a bus or through some other known or convenient device.

This disclosure contemplates the computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 500 may include one or more computer systems 500; be unitary or distributed; span multiple locations; span multiple machines; or reside in a cloud, which may include one or more cloud components in one or more networks. Where appropriate, one or more computer systems 500 may perform without substantial spatial or temporal limitation one or more steps of one or more methods described or illustrated herein. As an example and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

The processor may be, for example, a conventional microprocessor such as an Intel Core microprocessor or an Intel Itanium microprocessor or a Motorola power PC microprocessor or a SPARC architecture processor. One of skill in the relevant art will recognize that the terms “machine-readable (storage) medium” or “computer-readable (storage) medium” include any type of device that is accessible by the processor.

The memory is coupled to the processor by, for example, a bus. The memory can include, by way of example but not limitation, random access memory (RAM), such as dynamic RAM (DRAM) or static RAM (SRAM). The memory can be local, remote, or distributed.

The bus also couples the processor to the non-volatile memory and drive unit. The non-volatile memory cane be a magnetic floppy or hard disk, a magnetic-optical disk, an optical disk, a flash memory such as NAND flash memory or NOR flash memory, a read-only memory (ROM) such as a CD-ROM, a programmable read-only memory such as EPROM or EEPROM, a magnetic or optical card, or another form of storage for large amounts of data. Some of this data is often written, by a direct memory access process, into memory during execution of software in the computer 500. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

The bus also couples the processor to the network interface device. The interface can include one or more of a modem or network interface. It will be appreciated that a modem or network interface can be considered to be part of the computer system 500. The interface can include an analog modem, ISDN modem, cable modem, token ring interface, satellite transmission interface (e.g., “direct PC”), Wi-Fi interface, or other interfaces for coupling a computer system to other computer systems. The interface can include one or more input and/or output devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device. For simplicity, it is assumed that controllers of any devices not depicted in the example of FIG. 5 reside in the interface.

The computer system can have one Bus or multiple Buses. A bus can include for example, a system bus, a Peripheral Component Interconnect (PCI) bus or PCI-Express bus, a HyperTransport or industry standard architecture (ISA) bus, a small computer system interface (SCSI) bus, a universal serial bus (USB, USB 2.0, USB 3.0), IIC (I2C) bus, an Institute of Electrical and Electronics Engineers (IEEE) standard 1394 bus, also called “Firewire,” a QuickPath Interconnect bus, a ThunderBolt interconnect bus, a DisplayPort interconnect bus or its companion standards Mini DisplayPort (mDP), Direct Drive Monitor (DDM), Embedded DisplayPort (eDP), Internal DisplayPort (iDP), Portable Digital Media Interface (PDMI), Wireless DisplayPort (wDP), and Mobility DisplayPort (MyDP), an HDMI interconnect bus, a DVI bus.

In operation, the computer system 500 can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux™ operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may thus be implemented using a variety of programming languages.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a laptop computer, a tablet, a set-top box (STB), a personal digital assistant (PDA), a cellular telephone, an iPhone, a Blackberry, a smart phone, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies or modules of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), Blu-ray disks, among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

A person having ordinary skill in the art will appreciate that there are various other ways to implement the described functionality. The scope of this invention also includes embodiments implementing the described functionality in these various other ways. Accordingly, the scope of the present invention is intended to embrace all such alternatives, modifications, and variations as fall within the scope of the claims, together with all equivalents thereof.

Numerous specific details are set forth in order to provide a thorough understanding of embodiments of the present invention. It will be apparent, however, to one skilled in the art that embodiments of the present invention may be practiced without some of these specific details. In other instances, well-known structures and devices are shown in block diagram form.

Embodiments of the present invention include various steps. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

### CONCLUSION

In conclusion, the present invention provides novel apparatuses, methods, and arrangements for a dual-interface flash drive. While detailed descriptions of one or more embodiments of the invention have been given above, various alternatives, modifications, and equivalents will be apparent to those skilled in the art without varying from the spirit of the invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof. Therefore, the above description should not be taken as limiting the scope of the invention, which is defined by the appended claims.

What is claimed is:

1. A method for ensuring software quality using a virtual appliance comprising:
performing a first full compliance validation of the virtual appliance to verify that the virtual appliance complies with a governmental regulation;
enabling a first party to implement an instance of the virtual appliance by providing information regarding a process for implementing an instance of the virtual appliance; and
enabling a second party to verify that the instance of the virtual appliance complies with the governmental regulation by ensuring that the process is executed correctly, and not by performing a second full compliance validation.

2. The method of claim 1, further comprising:
ensuring that the process for implementing an instance the virtual appliance, when executed correctly, creates an instance of the virtual appliance that is in compliance with the governmental regulation.

3. The method of claim 1, wherein the process for implementing an instance of the virtual appliance includes applying a configuration to the virtual appliance.

4. The method of claim 1, wherein the governmental regulation is 21 CFR 11.

5. The method of claim 1, wherein the first full compliance validation is identical to the second full compliance validation.

6. The method of claim 1, wherein the first party and the second party are a same party.

7. A method for ensuring software quality using a virtual appliance comprising:
creating, after a first party performs a first full compliance validation of the virtual appliance to verify that the virtual appliance complies with a governmental regulation, an instance of the virtual appliance by following a process for implementing an instance of the virtual appliance; and
validating that the instance of the virtual appliance complies with the governmental regulation by ensuring that the process is executed correctly, and not by performing a second full compliance validation.
